(19) United States
(12) Patent Application Publication
(10) Pub. No.: US 2026/0157361 A1
(43) Pub. Date: Jun. 11, 2026

(54) Tractor Implement for Removing Plants

(71) Applicant: Monte Barnes, Uvalde, TX (US)

(72) Inventor: Monte Barnes, Uvalde, TX (US)

(21) Appl. No.: 19/229,735

(22) Filed: Jun. 5, 2025

Related U.S. Application Data
(60) Provisional application No. 63/656,656, filed on Jun. 6, 2024.

(51) Int. Cl. A01M 21/02

(52) U.S. Cl. CPC A01M 21/02

(57) ABSTRACT

A modular tractor implement system for removing prickly pear cactus and other undesirable plants comprises three plate assemblies with specialized tines. A bottom plate assembly includes pointed tines for soil penetration and root severing, while two side plate assemblies provide containment during collection and transport. The system attaches to existing tractor buckets using clips, set screws, and ratchet boomers, enabling efficient plant removal without permanent equipment modifications. The implement ensures complete root system removal while safely containing dangerous plant material, significantly improving efficiency and safety compared to conventional removal methods.

### CROSS REFERENCES TO RELATED APPLICATION

Not applicable.

### FEDERALLY SPONSORED RESEARCH OR DEVELOPMENT

Not applicable.

### BACKGROUND OF THE INVENTION

### 1. Field of the Invention

This invention relates to agricultural implements for plant removal, specifically tractor-mounted devices for removing undesired vegetation. This invention improves the efficiency and safety of removing prickly pear cactus and other deep-rooted plants by enabling complete root system extraction while containing the removed plant material.

### 2. Description of the Related Art

Existing plant removal devices in the agricultural industry typically employ plows, axes, shredders, mowers, and various cutting implements. While these conventional devices demonstrate effectiveness for removing many types of vegetation, they suffer from significant shortcomings when addressing prickly pear cactus and similar resilient plants.

Prickly pear cactus presents unique challenges that render conventional removal methods inadequate. First, successful eradication requires complete removal of the root system, as any remaining root portions will regenerate new growth rapidly. Second, the cactus pads are fragile and easily break apart when handled improperly, creating multiple smaller plants that can take root. Third, the numerous sharp spines covering the plant create safety hazards for operators attempting manual removal or using handheld tools.

Conventional plowing equipment typically cuts or breaks the cactus above ground level, leaving the root system intact and allowing regrowth. Shredding devices fragment the plant into numerous pieces, each capable of establishing new growth when scattered across the land. Existing bucket attachments for tractors and loaders lack the specialized tines and containment features necessary for effective cactus removal.

Current methods also fail to address the need for efficient collection and transport of removed plant material. Without proper containment, broken cactus pieces fall from equipment during transport, spreading the problem rather than solving it. The related art fails to provide a comprehensive solution that addresses root system removal, plant containment, operator safety, and operational efficiency in a single integrated system.

### SUMMARY OF THE INVENTION

The present invention was developed to address the problems discussed above. The invention provides a specialized tractor implement system comprising multiple plates with extending tines, designed to attach to existing tractor buckets for efficient removal of prickly pear cactus and other undesirable plants.

In at least one embodiment, the invention comprises three plates: a bottom plate and two side plates. Each plate includes a plurality of tines extending away from the plate surface. The bottom plate features pointed tines specifically designed for penetrating soil and severing root systems, while the side plates include containment tines to prevent plant material from falling out during collection and transport.

The attachment system includes clips and set screws that secure each plate to corresponding surfaces of a tractor bucket, along with ratchet boomers extending from the bottom plate to provide additional securing force. This modular design allows the implement to be quickly installed on or removed from existing tractor equipment without permanent modifications.

The invention enables operators to efficiently remove entire prickly pear plants including their root systems in a single operation, while safely containing the removed material for proper disposal. The implement significantly reduces labor time, improves safety by eliminating manual handling of dangerous cactus plants, and prevents regrowth by ensuring complete root removal.

### BRIEF DESCRIPTION OF THE SEVERAL VIEWS OF THE DRAWINGS

For an improved understanding of the present invention, and the advantages thereof, reference is made to the following descriptions taken in conjunction with the accompanying drawings. The accompanying drawings illustrate several embodiments and, together with the description, serve to explain the principles of the invention according to the embodiments. It will be appreciated by one skilled in the art that the particular arrangements illustrated in the drawings are merely exemplary and are not to be considered as limiting of the scope of the invention or the claims herein in any way.

FIG. 1 is a top view of the bottom plate assembly showing the plate structure and extending tines.

FIG. 2 is a bottom view of the bottom plate assembly illustrating the clip attachment mechanism.

FIG. 3 is a side view of a first side plate assembly showing tines and attachment hardware.

FIG. 4 is a side view of a second side plate assembly showing tines and attachment hardware.

FIG. 5 is a side view of the bottom plate assembly.

FIG. 6 is an opposite side view of the bottom plate assembly.

FIG. 7 is a perspective view of the complete implement system attached to a loader bucket.

FIG. 8 is a perspective view of the implement system in operation, removing prickly pear cactus.

### DETAILED DESCRIPTION OF THE INVENTION

### 1. General Considerations

The present invention disclosure is for a modular tractor implement system specifically designed for removing undesired plants, particularly prickly pear cactus. The invention is described by reference to various elements herein. It should be noted, however, that although the various elements of the inventive apparatus are described separately below, the elements need not necessarily be separate. The various embodiments may be interconnected and may be cut out of a singular block or mold. The variety of different ways of forming an inventive apparatus, in accordance with the disclosure herein, may be varied without departing from the scope of the invention.

Generally, one or more different embodiments may be described in the present application. Further, for one or more of the embodiments described herein, numerous alternative arrangements may be described; it should be appreciated that these are presented for illustrative purposes only and are not limiting of the embodiments contained herein or the claims presented herein in any way. One or more of the arrangements may be widely applicable to numerous embodiments, as may be readily apparent from the disclosure. In general, arrangements are described in sufficient detail to enable those skilled in the art to practice one or more of the embodiments, and it should be appreciated that other arrangements may be utilized and that structural changes may be made without departing from the scope of the embodiments. Particular features of one or more of the embodiments described herein may be described with reference to one or more particular embodiments or figures that form a part of the present disclosure, and in which are shown, by way of illustration, specific arrangements of one or more of the aspects. It should be appreciated, however, that such features are not limited to usage in the one or more particular embodiments or figures with reference to which they are described. The present disclosure is neither a literal description of all arrangements of one or more of the embodiments nor a listing of features of one or more of the embodiments that must be present in all arrangements.

Headings of sections provided in this patent application and the title of this patent application are for convenience only and are not to be taken as limiting the disclosure in any way.

Devices and parts that are connected to each other need not be in continuous connection with each other, unless expressly specified otherwise. In addition, devices and parts that are connected with each other may be connected directly or indirectly through one or more connection means or intermediaries.

A description of an aspect with several components in connection with each other does not imply that all such components are required. To the contrary, a variety of optional components may be described to illustrate a wide variety of possible embodiments and in order to more fully illustrate one or more embodiments. Similarly, although process steps, method steps, or the like may be described in a sequential order, such processes and methods may generally be configured to work in alternate orders, unless specifically stated to the contrary. In other words, any sequence or order of steps that may be described in this patent application does not, in and of itself, indicate a requirement that the steps be performed in that order. The steps of described processes may be performed in any order practical. Further, some steps may be performed simultaneously despite being described or implied as occurring non-simultaneously (e.g., because one step is described after the other step). Moreover, the illustration of a process by its depiction in a drawing does not imply that the illustrated process is exclusive of other variations and modifications thereto, does not imply that the illustrated process or any of its steps are necessary to one or more of the embodiments, and does not imply that the illustrated process is preferred. Also, steps are generally described once per aspect, but this does not mean they must occur once, or that they may only occur once each time a process, or method is carried out or executed. Some steps may be omitted in some embodiments or some occurrences, or some steps may be executed more than once in a given aspect or occurrence.

When a single device or article is described herein, it will be readily apparent that more than one device or article may be used in place of a single device or article. Similarly, where more than one device or article is described herein, it will be readily apparent that a single device or article may be used in place of the more than one device or article.

The functionality or features of a device may be alternatively embodied by one or more other devices that are not explicitly described as having such functionality or features. Thus, other embodiments need not include the device itself.

Techniques and mechanisms described or referenced herein will sometimes be described in singular form for clarity. However, it should be appreciated that particular embodiments may include multiple iterations of a technique or multiple instantiations of a mechanism unless noted otherwise. Alternate implementations are included within the scope of various embodiments in which, for example, functions may be executed out of order from that shown or discussed, including substantially concurrently or in reverse order, depending on the functionality involved, as would be understood by those having ordinary skill in the art.

### 2. Considerations Specific to the Invention

The invention comprises a multi-plate implement system designed for attachment to existing tractor buckets. The system includes a bottom plate assembly 20a, a first side plate assembly 20b, and a second side plate assembly 20c. Each plate assembly incorporates specialized tines configured for specific functions in the plant removal process.

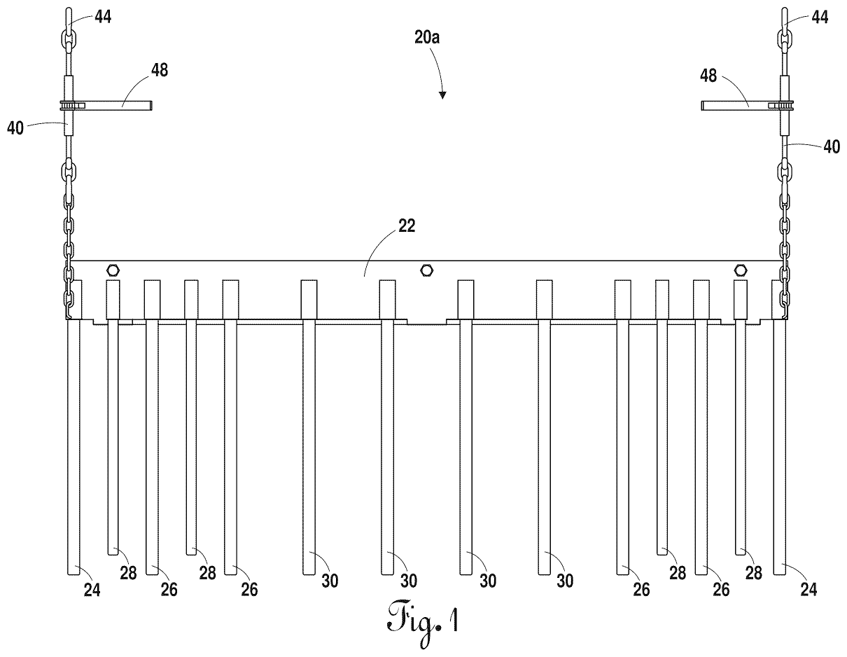

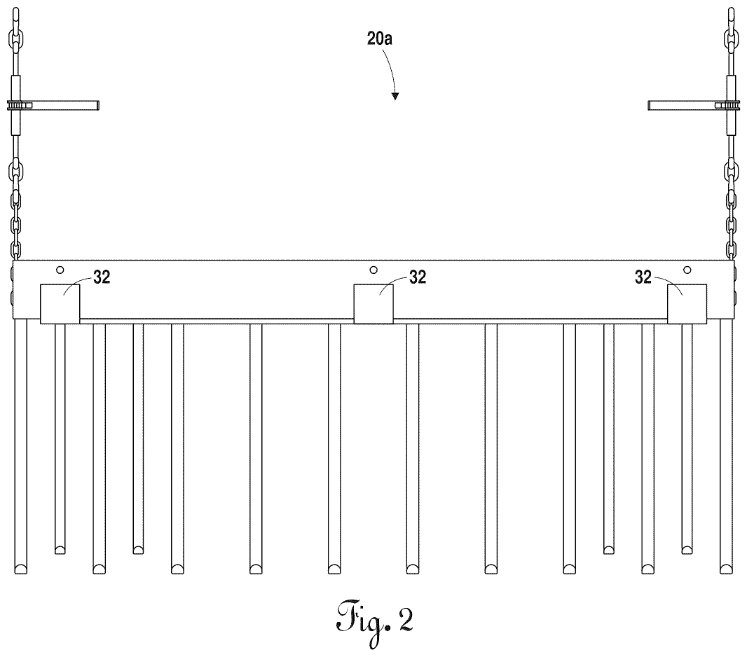

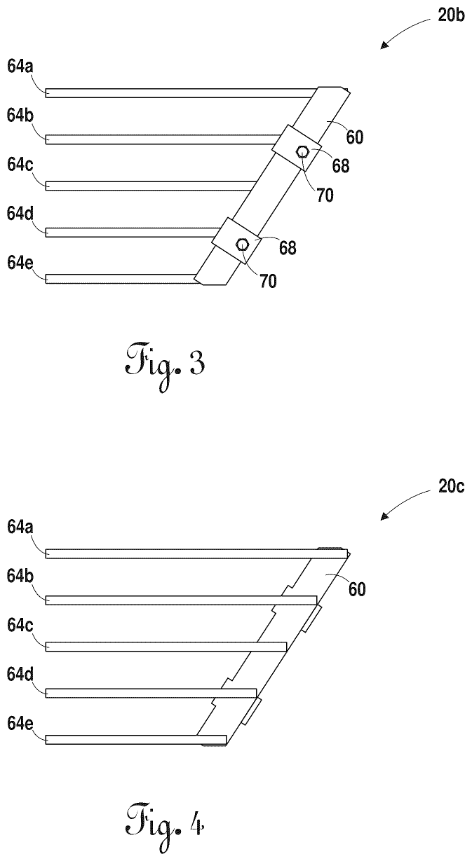

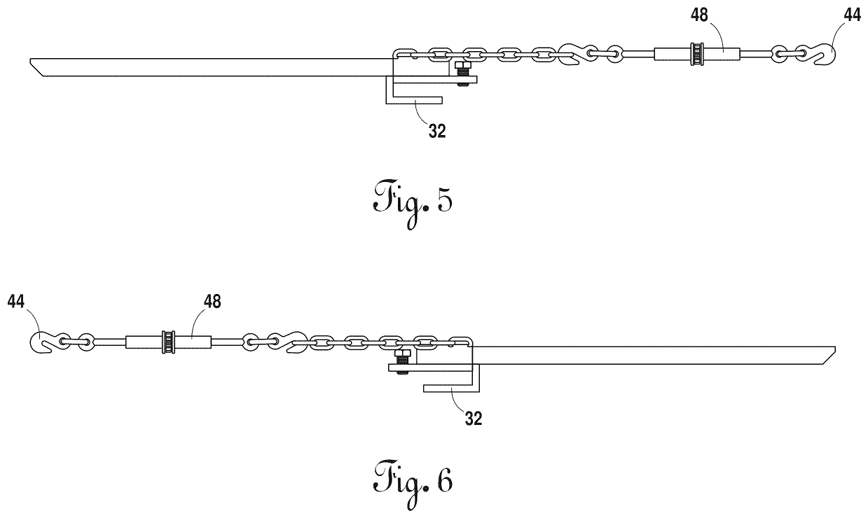

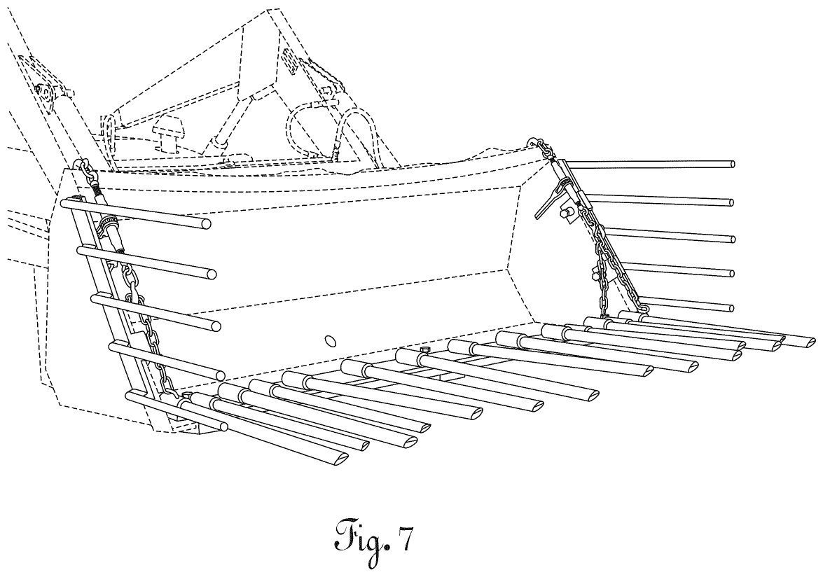

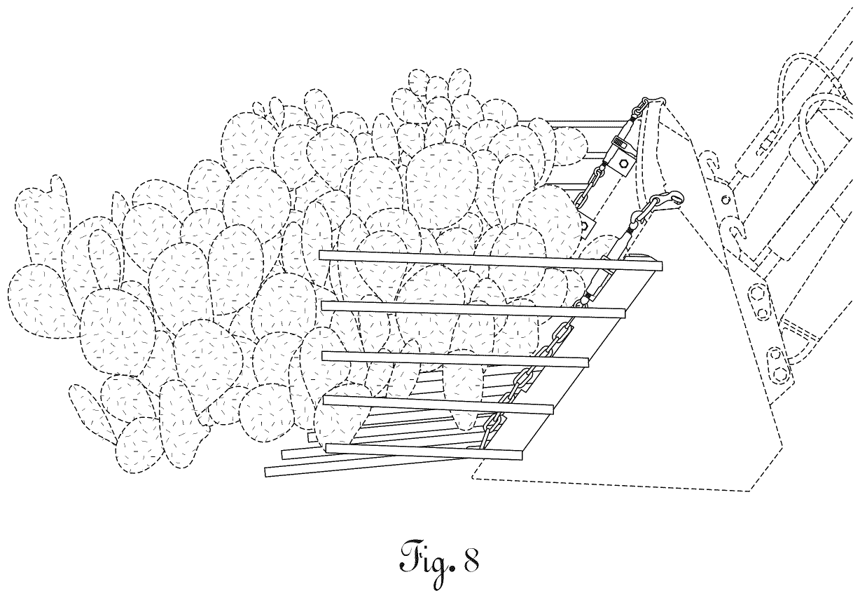

Referring to FIG. 1, the bottom plate assembly 20a includes a mounting plate 22 from which multiple tines extend forward. In the illustrated embodiment, fourteen tines are provided in two distinct configurations: ten larger tines 24, 26, 30 constructed from 1.25-inch diameter round rod, and four smaller tines 28 constructed from 1-inch diameter round rod. The larger tines are positioned on 8-inch centers and extend 30 inches in total length, with 26 inches extending forward of the bucket. The smaller tines 28 are positioned on 4-inch centers and extend 28 inches in total length, with 24 inches extending forward of the bucket.

All tines 24, 26, 28, 30 on the bottom plate assembly 20a are beveled on their bottom surfaces to reduce soil resistance during operation. The pointed configuration of these tines enables effective penetration through soil and root systems. The varying tine spacing creates zones of different functionality: wider spacing in the center allows targeting of larger plant trunks and main root systems, while closer spacing on the exterior provides fine collection and prevents smaller plant fragments from escaping.

Each tine is secured within a pipe sleeve 32 welded to the mounting plate 22. This construction provides structural strength while allowing for potential tine replacement or modification. The mounting plate 22 comprises ½-inch by 6-inch flat iron extending 6 feet in length, providing adequate strength for the forces encountered during plant removal operations.

The bottom plate assembly 20a incorporates multiple attachment mechanisms for secure connection to the tractor bucket. Three clips 32, constructed from ½-inch angle iron measuring 2 inches tall, 4 inches wide, and 4 inches long, are welded to the bottom of the mounting plate and hook onto the bottom edge of the bucket. Three set screws 34, sized ¾-inch by 1.25 inches, are positioned 4 inches from each end and at the center of the mounting plate to provide adjustable clamping force against the clips.

Additional securing force is provided by two ratchet boomers 48, each rated at 2500 pounds capacity. The ratchet boomers connect via chains 40 extending from opposing ends of the bottom plate assembly to hooks 44 that engage the top edge of the bucket. This arrangement creates a triangulated support system that distributes operational loads across multiple attachment points.

The side plate assemblies 20b and 20c each comprise a mounting plate 60 from which five tines 64a, 64b, 64c, 64d, 64e extend horizontally. These tines are constructed from ⅞-inch diameter rod and vary in length to accommodate the angled orientation of the bucket sides. Typical lengths include 30, 27, 24, 21, and 18 inches, positioned on 4 and ⅝-inch centers. The varying lengths ensure that all tine tips terminate in a common plane perpendicular to the bucket opening, creating an effective containment barrier.

Each side plate assembly includes two clips 68 and corresponding set screws 70 for attachment to the bucket sides. The clips, constructed from ½-inch angle iron measuring 1.5 inches tall, 3 inches wide, and 4 inches long, provide secure engagement with the bucket edges. The set screws, sized ¾-inch by 1.25 inches, are positioned 5.5 and 16.5 inches from the bottom of the mounting plate to distribute clamping forces effectively.

In operation, the implement system functions as an integrated unit. The bottom plate assembly penetrates the soil around target plants, using its pointed tines to sever root systems and lift entire plants. The side plate assemblies prevent plant material from falling out during collection and transport, ensuring efficient cleanup and preventing re-establishment of fragments.

This application has presented several embodiments of the present invention and discussed various devices. It is contemplated that these units and devices may exist in varying arrangements, combinations, and still reflect the spirit of the present invention.

Alternative embodiments may incorporate different tine configurations. For example, uniform tine spacing of 4 inches or less across the entire bottom plate would prevent any soil or debris from passing through, creating a more aggressive collection system. Conversely, wider spacing throughout would allow for faster operation in sandy soils where fine debris retention is less critical.

In some embodiments, the tines may be constructed from different materials or incorporate different tip configurations. Hardened steel tips could be welded or attached to standard rod tines for enhanced durability in rocky soils. Curved or angled tines could provide specialized functions such as lifting or cutting actions.

Alternative attachment mechanisms may be employed in different embodiments. Quick-release pins could replace set screws for faster installation and removal. Hydraulic or pneumatic clamping systems could provide more consistent clamping forces. Magnetic attachment systems could be incorporated for rapid deployment on steel buckets.

The side plate assemblies may be configured as removable components for applications where containment is not required. Alternatively, additional side plates could be incorporated to create a completely enclosed collection system. Height-adjustable side plates could accommodate different plant types and collection requirements.

Power-assisted embodiments may incorporate hydraulic cylinders to adjust tine angle or penetration depth during operation. Vibrating mechanisms could be added to enhance soil penetration or aid in plant separation. Rotating tine assemblies could provide active cutting action for particularly tough root systems.

The implement system may be scaled for different tractor sizes and bucket configurations. Smaller versions could be designed for compact tractors and utility vehicles. Larger versions could incorporate additional tine arrays or wider coverage areas for commercial agricultural applications.

Specialized embodiments may target specific plant types beyond prickly pear cactus. Modified tine configurations could address tree saplings, brush, or other problematic vegetation. Adjustable tine spacing could accommodate varying plant densities and root configurations.

The mounting plate material and thickness may be varied based on anticipated loads and operating conditions. Heavier-duty applications might employ thicker plates or reinforced construction. Lightweight versions could use aluminum or composite materials for reduced weight and easier handling.

Manufacturing and Material Alternative Embodiments. In alternative embodiments, the tines may be constructed as removable and replaceable components rather than permanently welded assemblies. Threaded connections may be employed where each tine includes external threading that engages internal threading within the pipe sleeves. This configuration allows for field replacement of damaged tines or substitution of different tine types for varying soil conditions. Bayonet mount systems may alternatively be used, where tines include radial projections that engage corresponding slots in the sleeves, allowing quarter-turn installation and removal. Pin-secured connections may employ transverse pins or bolts passing through aligned holes in both the tine and sleeve.

Material alternatives may significantly alter the implement's performance characteristics. High-strength aluminum alloy construction reduces overall weight by approximately 40-60% compared to steel, enabling use with smaller tractors while maintaining structural integrity. Composite materials such as fiber-reinforced polymers provide excellent corrosion resistance for coastal or high-moisture environments while offering comparable strength-to-weight ratios. Hardened steel components may be employed for extreme-duty applications involving rocky soils or highly abrasive conditions, with tine tips heat-treated to Rockwell hardness levels of 45-55 HRC.

Surface treatments and coatings may be applied to enhance durability and performance. Powder coating provides corrosion protection and can incorporate bright colors for improved visibility and safety. Hot-dip galvanizing offers superior long-term corrosion resistance in outdoor storage conditions. Wear-resistant coatings such as tungsten carbide or ceramic materials may be applied to tine tips and high-wear areas to extend service life in abrasive soil conditions.

Functional Enhancement Embodiments. Adjustable tine systems provide operational flexibility for varying conditions. Telescoping tines may incorporate sliding mechanisms allowing length adjustment from 18 to 36 inches to accommodate different plant sizes and soil conditions. Locking mechanisms such as pin-and-hole arrays or threaded collars secure the desired extension length. Pivoting tine assemblies may incorporate hinge mechanisms allowing tine angle adjustment from vertical to 45 degrees forward or backward, optimizing approach angle for different plant types and soil hardness.

Active vibration systems may be integrated to enhance soil penetration and plant separation effectiveness. Pneumatic vibrators operating at frequencies of 50-200 Hz can be mounted to mounting plates and powered by the tractor's compressed air system. Hydraulic vibration systems may employ oscillating hydraulic cylinders connected to the tractor's hydraulic circuit. Electric vibration systems using 12V or 24V motors with eccentric weights provide self-contained operation without requiring additional tractor systems.

Hydraulic integration embodiments incorporate the tractor's hydraulic system for enhanced functionality. Hydraulic cylinders may be positioned to adjust the angle of side plates from vertical to 30 degrees inward, providing variable containment geometry. Hydraulic downforce systems may apply additional penetration force through cylinders connected between the bucket and implement assembly. Hydraulic tine positioning systems may allow real-time adjustment of tine spacing or angle during operation.

Specialized Configuration Embodiments. Single-plate embodiments eliminate the side plate assemblies for applications where plant containment is not required or where bucket width is limited. These configurations reduce weight and complexity while maintaining the core root-severing functionality. The bottom plate assembly may be scaled proportionally larger to compensate for the lack of side containment.

Multi-level tine array embodiments incorporate tines at different vertical positions to create staged plant extraction. A first level of shorter tines positioned 2-4 inches above the primary tine level can engage upper root systems or smaller plants, while the primary tines address main root systems. This configuration improves collection efficiency for mixed vegetation densities.

Curved or angled plate configurations may be employed to match specific bucket geometries or provide specialized functionality. Concave mounting plates following the bucket's curve may improve load distribution and reduce stress concentrations. Angled plates positioned at 15-30 degrees relative to the bucket face may provide improved approach angles for certain plant types or terrain conditions.

Attachment System Variations. Quick-connect embodiments eliminate the need for tools during installation and removal. Lever-operated cam clamps may replace set screws, allowing hand operation without wrenches or tools. Quick-release pin systems may employ spring-loaded pins with pull-handles for rapid engagement and disengagement of mounting points. Magnetic attachment systems using rare-earth magnets rated for 500-1000 pounds holding force may be incorporated for steel bucket applications.

Universal mounting systems accommodate multiple bucket types and sizes through adjustable hardware. Sliding mounting brackets may adjust to bucket widths ranging from 48 to 84 inches. Adjustable clip assemblies may accommodate bucket edge thicknesses from ¼ inch to 1 inch. Modular chain lengths and multiple hook positions may accommodate buckets of varying depth and height.

Permanent integration embodiments incorporate the tine assemblies directly into custom bucket designs during manufacturing. Welded integration eliminates separate mounting plates and attachment hardware while optimizing load paths for maximum strength. Integral tine mounting may incorporate reinforcement ribs and gussets not feasible with retrofit installations.

Application-Specific Embodiments. Compact embodiments scaled for utility tractors and small agricultural equipment may incorporate proportionally smaller components while maintaining functional relationships. Tine counts may be reduced to 6-8 on the bottom plate while maintaining 2-4 inch spacing. Overall implement width may be reduced to 36-48 inches to match smaller bucket sizes.

Heavy-duty embodiments for large agricultural equipment may incorporate enhanced structural elements and increased tine counts. Bottom plates may support 20-30 tines to cover bucket widths of 8-12 feet. Tine diameters may be increased to 1.5-2.0 inches for enhanced strength. Multiple ratchet boomers rated at 5000+ pounds each may be employed for extreme loading conditions.

Plant-specific configuration embodiments optimize tine patterns for different vegetation types. Brush removal configurations may employ closely-spaced straight tines with cutting edges. Tree sapling removal may incorporate curved tines designed to hook and lift rather than pierce. Alternative cactus species may require different tine spacing and penetration depths based on their root system characteristics.

The present invention is described above in terms of a preferred illustrative embodiment in which a specifically described tractor implement for removing plants is described. Those skilled in the art will recognize that alternative constructions of such an apparatus, system, and method can be used in carrying out the present invention. Other aspects, features, and advantages of the present invention may be obtained from a study of this disclosure and the drawings, along with the appended claims.

### 3. Additional Considerations

As used herein any reference to “one embodiment” or “an embodiment” means that a particular element, feature, structure, or characteristic described in connection with the embodiment is included in at least one embodiment. The appearances of the phrase “in one embodiment” in various places in the specification are not necessarily all referring to the same embodiment.

Some embodiments may be described using the expression “coupled” and “connected” along with their derivatives. For example, some embodiments may be described using the term “coupled” to indicate that two or more elements are in direct physical or electrical contact. The term “coupled,” however, may also mean that two or more elements are not in direct contact with each other, but yet still co-operate or interact with each other. The embodiments are not limited in this context.

As used herein, the terms “comprises,” “comprising,” “includes,” “including,” “has,” “having” or any other variation thereof, are intended to cover a non-exclusive inclusion. For example, a process, method, article, or apparatus that comprises a list of elements is not necessarily limited to only those elements but may include other elements not expressly listed or inherent to such process, method, article, or apparatus. Further, unless expressly stated to the contrary, “or” refers to an inclusive or and not to an exclusive or. For example, a condition A or B is satisfied by any one of the following: A is true (or present) and B is false (or not present), A is false (or not present) and B is true (or present), and both A and B are true (or present).

In addition, use of the “a” or “an” are employed to describe elements and components of the embodiments herein. This is done merely for convenience and to give a general sense of the invention. This description should be read to include one or at least one and the singular also includes the plural unless it is obvious that it is meant otherwise.

Upon reading this disclosure, those of skill in the art will appreciate still additional alternative structural and functional designs for a system and a process for removing plants using specialized tractor-mounted implements through the disclosed principles herein. Thus, while particular embodiments and applications have been illustrated and described, it is to be understood that the disclosed embodiments are not limited to the precise construction and components disclosed herein. Various apparent modifications, changes and variations may be made in the arrangement, operation and details of the method and apparatus disclosed herein without departing from the spirit and scope defined in the appended claims.

We claim:

1. A tractor implement system comprising:
a bottom plate assembly having a first mounting plate and a first plurality of tines extending therefrom;
a first side plate assembly having a second mounting plate and a second plurality of tines extending therefrom; and
a second side plate assembly having a third mounting plate and a third plurality of tines extending therefrom.

2. The tractor implement system of claim 1 wherein:
the first plurality of tines includes at least two distinct sets of tines having different dimensions; and
wherein a first set of tines from the first plurality extends a first distance from the first mounting plate and a second set of tines from the first plurality extends a second distance from the first mounting plate, the first distance being greater than the second distance.

3. The tractor implement system of claim 1 further comprising attachment hardware configured to secure each mounting plate to a corresponding surface of a tractor bucket.

4. The tractor implement system of claim 3, wherein the attachment hardware comprises:
clips extending from each mounting plate configured to engage edges of the tractor bucket;
set screws positioned to apply clamping force between the clips and the tractor bucket; and
wherein the tensioning mechanism comprises chains extending from the bottom plate assembly to hooks configured to engage a top edge of the tractor bucket.

5. The tractor implement system of claim 1 further comprising at least one tensioning mechanism extending between the bottom plate assembly and an opposing surface of the tractor bucket.

6. The tractor implement system of claim 5, wherein the tensioning mechanism comprises:
two ratchet boomers;
chains connecting the ratchet boomers to opposing ends of the bottom plate assembly; and
hooks at terminal ends of the chains configured to engage a top edge of the tractor bucket.

7. The tractor implement system of claim 1, wherein:
the first plurality of tines includes pointed tips configured for soil penetration and root severing;
the second plurality of tines and third plurality of tines include blunt tips configured for plant material containment;
the second plurality of tines and third plurality of tines vary in length to accommodate angled bucket surfaces while maintaining tip alignment in a common plane.

8. The tractor implement system of claim 1, further comprising pipe sleeves welded to each mounting plate, wherein each tine is secured within a corresponding pipe sleeve; and wherein each tine in the first plurality includes a beveled bottom surface to reduce soil resistance during operation.

9. A tractor implement system comprising:
a bottom plate assembly having a first mounting plate and a first plurality of tines extending therefrom, the first plurality of tines including at least two distinct sets of tines having different dimensions, wherein a first set of tines from the first plurality extends a first distance from the first mounting plate and a second set of tines from the first plurality extends a second distance from the first mounting plate, the first distance being greater than the second distance, the first plurality of tines including pointed tips configured for soil penetration and root severing, each tine in the first plurality including a beveled bottom surface to reduce soil resistance during operation;
a first side plate assembly having a second mounting plate and a second plurality of tines extending therefrom, the second plurality of tines including blunt tips configured for plant material containment and varying in length to accommodate angled bucket surfaces while maintaining tip alignment in a common plane;
a second side plate assembly having a third mounting plate and a third plurality of tines extending therefrom, the third plurality of tines including blunt tips configured for plant material containment and varying in length to accommodate angled bucket surfaces while maintaining tip alignment in a common plane;
pipe sleeves welded to each mounting plate, wherein each tine is secured within a corresponding pipe sleeve;
attachment hardware configured to secure each mounting plate to a corresponding surface of a tractor bucket, the attachment hardware comprising clips extending from each mounting plate configured to engage edges of the tractor bucket and set screws positioned to apply clamping force between the clips and the tractor bucket; and
two ratchet boomers connected by chains to opposing ends of the bottom plate assembly, the chains having hooks at terminal ends configured to engage a top edge of the tractor bucket.

10. A method of removing plants using a tractor implement system comprising the following steps:
attaching a bottom plate assembly to a bottom surface of a tractor bucket;
attaching a first side plate assembly and a second side plate assembly to opposing side surfaces of the tractor bucket;
engaging a tensioning mechanism to secure the bottom plate assembly;
positioning the tractor implement system adjacent to one or more target plants;
penetrating soil around the target plants using a first plurality of tines;
severing root systems of the target plants;
lifting the target plants with their root systems attached; and
containing the target plants using a second plurality of tines and a third plurality of tines during transport.

11. The method of claim 10, wherein the step of penetrating soil comprises:
using the first set of tines to target main root systems and plant trunks;
using the second set of tines to collect smaller plant fragments and prevent escape of plant material.

12. The method of claim 10, wherein the step of penetrating soil comprises:
adjusting one or more set screws to adjust clamping force on the tractor bucket;
tensioning the ratchet boomers to distribute operational loads across multiple attachment points.
